(19) United States
(12) Patent Application Publication
(10) Pub. No.: US 2008/0049979 A1
(43) Pub. Date: Feb. 28, 2008

(54) Home entertainment chart and method of using same

(75) Inventors: Jeff Schindler, Irvine, CA (US); Ken Lowe, Irvine, CA (US)

Correspondence Address: KLEINBERG & LERNER, LLP, 2049 CENTURY PARK EAST, SUITE 1080, LOS ANGELES, CA, 90067, US

(73) Assignee: Vizio, Inc., Irvine, CA (US)

(21) Appl. No.: 11/890,959

(22) Filed: Aug. 7, 2007

Related U.S. Application Data
(60) Provisional application No. 60/823,468, filed on Aug. 24, 2006.

(51) Int. Cl. G06K 9/00

(52) U.S. Cl. 382/113

(57) ABSTRACT

A chart and method of creating and using said chart is described whereby a user may easily ascertain how to connect many and varied devices to an electronic device by any number of means. The chart is color-coded and organized by rows and columns to aid in ease of use and understanding by a user who may not be familiar with electronic devices and their connections. Furthermore, it contains detailed depictions of the connection means and cabling required so as to aid in identifying the proper connection means for any number of these devices.

This application claims priority based upon the provisional patent application Ser. No. 60/823,468 entitled Method for Providing Instructions for Electronic Equipment filed on Aug. 24, 2006.

### BACKGROUND

1. Field of the Invention

The present invention relates to connecting electronic component equipment together. Particularly, a chart that shows the cables and connections associated with the various television set inputs, signal source and equipment outputs and methods of creating and using such a chart.

2. Description of the Related Art

In recent years, the act of installing a television set has become considerably more complex. The rise of home entertainment technology has lead to an increase in the number of devices and signal source that can be connected to a television. There has been a corresponding rise in the different types of cables, signal source attachments, television inputs and equipment outputs to accommodate the equipment and signal sources. Compounding the problem, where users of television equipment previously had only a single cable or antenna they connected directly to the back of the television, now users have a multitude of accessory components. These components include audio receivers, external speaker systems and amplifiers for those systems, digital video disc players, video cassette recorders, stereos, satellite receivers, video game consoles, personal computers and the like. Each of these devices also has various and often many connections to the television and to each other.

In order to assist users with connecting all of the different equipment and signal sources to a television sets, manufactures have included manuals and quickstart guides that include connection diagrams with their products. However, the included documentation is invariably lacking because it does not illustrate the differences between the different cables, inputs and outputs at all or effectively. Rather, the connection diagrams simply depict a line between the television and equipment or signal source and the user is expected know which cable to use and which set of television set inputs and equipment outputs to use the cable with.

Occasionally, the manual or guide will show what the cable looks like. However, these depictions are invariably lacking in sufficient detail to differentiate between similar looking cables, such as RCA and component. As a result, users who are not familiar with the cables, inputs and outputs are left without the knowledge of what cables they need to buy and where to plug those cables.

The included documentation, designed to aid a user in connecting this equipment, is also unable to help. It is typically overly rigid because the included connection diagrams are often limited to a select few certain scenarios. For example, one diagram may show a television, DVD player and satellite connection only. Unfortunately, not all scenarios are covered and since the documentation did not provide the basic knowledge of informing the user which cable to use for particular inputs or outputs and where to plug it into the device. Therefore, if a user's equipment does not fit a particular scenario exactly, they will likely be unable to connect their television to the proper inputs and outputs.

As a result of the complexity of connecting equipment and signal sources to television sets along with inadequate documentation, manufacturers must devote considerable resources to technical support to assist users in connecting equipment. This support is typically provided by means of technical support hotlines or internet-based knowledge bases. The creation, maintenance and continual updating of the information available to technical support hotlines is costly and inefficient. Furthermore, the inability to use one's newly-purchased television (or other electronic equipment) immediately after purchase, then experiencing technical support hotlines with waits, delays and wasted time creates a negative experience for the end user at a time when they are most excited about the company, product and potential experience using the product. This scenario is one that a company wishes to avoid for cost and product experience reasons.

Consequently, there is a need for an apparatus and a method that permits users to easily identify the different cables used and where the cables connect equipment and signal sources to television sets. The chart of this invention is designed to fill that void and reduce the user's dependence on customer support by assisting users to easily connect their numerous equipment and signals sources to their television.

Furthermore, the method of creating and using the chart may be utilized for any number of electronics and is quickly understood by users. In practice, this invention has already resulted in a 50% reduction in technical support issues for the assignee of this invention and improved customer service cost and time-spent reductions. Furthermore, retailers are now requesting that the chart and method of this invention be disclosed to other product vendors in order to make the sale and set-up experience for those retailers' customers simpler.

### SUMMARY OF THE INVENTION

The invention provides a chart and methods of creating and using the chart to allow the user to easily determine what cable is needed to connect a given signal source or equipment to a television set. The chart and methods of creating and using the chart are not limited to use with televisions. In fact, they may be applicable to any number of electronic devices to enable a user to quickly and correctly connect them. The chart and methods also allow the user to identify which set of inputs on the television set is needed to connect the signal source or equipment as well as the outputs that are on the signal source or equipment. The chart and methods also allow the user to plan how to allocate the inputs on the television (or other device) to different equipment and signal types.

In recent years, there has been an explosion of home entertainment equipment and signal sources to connect to television sets. For example a few of the different equipment that can be connected to a television set includes, but is not limited to, digital video disc (DVD) players, video cassette recorders (VCRs), camcorders, computers, stereos and game consoles. The types of signal sources used to receive television broadcast are almost equally numerous, such as, antenna, analog cable, digital cable, satellite and high definition signals. All of the different equipment and signal sources connect to televisions by a variety of industry standard connection methods, including, HDMI, DVI, RF, analog and component. Each of the aforementioned connection methods uses its own specific cable that plugs into specific set of inputs associated with that connection method. Further confusing the user, several of the cables have very similar appearances, yet substantially different uses.

It is the aim of this invention to assist the user in easily connecting the myriad of equipment and signal sources to a television set (or other electronic device). The preferred embodiment of this invention is as a large chart that is packed along with the television set. This chart will clearly depict, using color coding and easy-to-understand columns, rows and lines, the various ways in which the television (or other electronic device) may be connected to various devices.

Another embodiment of the invention would be to include the chart as a portion of the manual for the television set. In this alternative embodiment, it would be preferred that the manual be printed in color so as to depict the color-coding clearly. Alternatively, the color coding may be substituted for some other form of coding, such as checking, hatching and houndstoothing the background if the manual is printed in black and white.

The chart consists of a series of tables and illustrations. The tables are aligned horizontally and have an identical number of rows that are connected by horizontal lines between the tables. Each row corresponds to one input of the television set. For example, if a television set has ten sets of inputs, there will ten rows for each table. The information is laid out in such a way that each table represents a step in the method of installing the equipment. The user moves follows the tables from left to right using the parallel horizontal lines to guide them from table to table.

Yet another feature of the chart is the connection map. The connection map is a labeled diagram which displays the locations of all the inputs on the television set's panel. This connection map depicts the placement of all relevant connections and a detailed depiction of the input connector and cabling used to connect to that input. The size and visibility of this connection map are not known in the prior art. This is a feature which is very useful to a user unfamiliar with the appearance of various connections on the television or the inputs which should be attached to them.

The chart also serves to aid the user in allocating the available inputs on the television according to their equipment and signal source needs. For example, the user will know by looking at the chart that their television set only has two analog HD inputs and can plan what will be connected to them. Therefore, a user can easily and quickly determine a “connection plan” on how to connect his various electronic components to the television (or other electronic device).

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

The patent application file contains at least one drawing executed in color. Copies of this patent or patent application publication with color drawing(s) will be provided by the Office upon request and payment of the necessary fee.

FIG. 1 is a perspective view of the invention;

FIG. 2 is a detailed view of signal sources and equipment table;

FIG. 3 is a detailed view of connection methods table;

FIG. 4 is a detailed view of the cable selector and connection reference tables;

FIG. 5 is a detailed view of the connection map.

FIG. 6 is a detailed view of the best connection legend.

FIG. 7 is a color perspective view of the invention;

FIG. 8 is a color detailed view of signal sources and equipment table;

FIG. 9 is a color detailed view of connection methods table;

FIG. 10 is a color detailed view of the cable selector and connection reference tables;

FIG. 11 is a color detailed view of the connection map.

FIG. 12 is a color detailed view of the best connection legend.

### DETAILED DESCRIPTION OF THE INVENTION

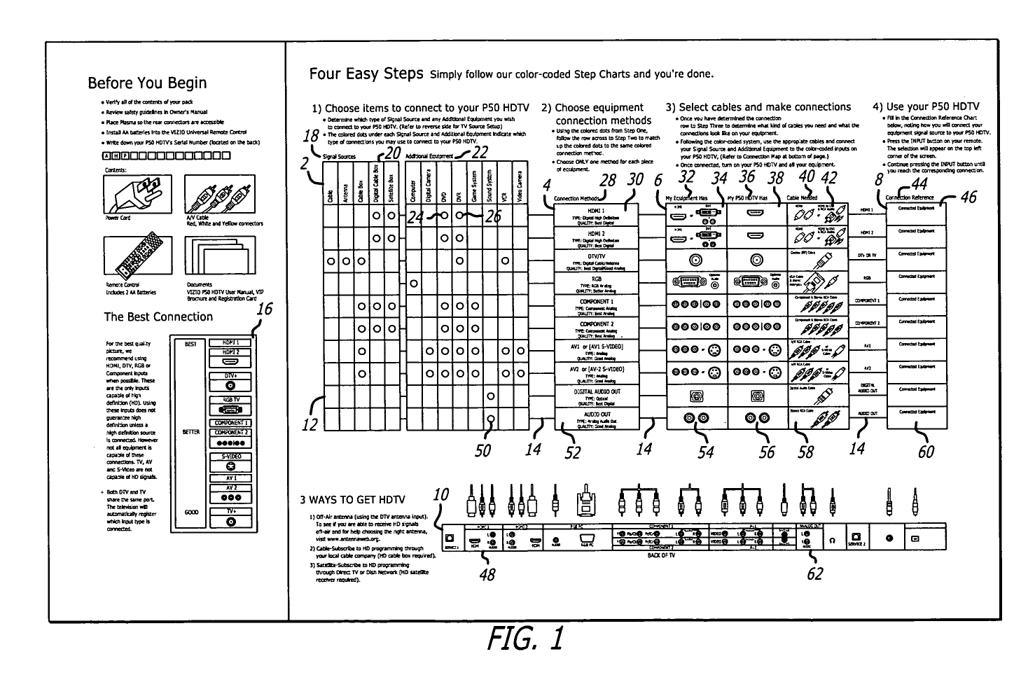

Turning first to FIG. 1 there is shown an example of a chart of the present invention. In the preferred embodiment, the chart is of substantial size, typically approximately 3 feet by 2.5 feet. It is intended to be large so that a user of virtually any technical skill level may read it and readily see the size, shape and type of connections between the various devices. It is a limitation of the prior art that charts and “quickstart guides” have been substantially small and imprecise that the end-user has a difficult time familiarizing him or herself with the device and relevant connections. This limitation is overcome by the present invention.

The chart is typically inserted along with a television in the box or alternatively, placed in the manual sent along with the television. The large size of the chart enables the user to more readily see the chart, the text, the color-coding and its various components while attempting to use the chart. The color-coding is not only per-line of the chart, but also includes the actual color of the various cables, connections and input points for the device and cabling. This enables a user to better acquaint themselves quickly with the device and its connections more quickly. The lack of very clear depictions of the device and cabling is another limitation of the prior art overcome by the present invention.

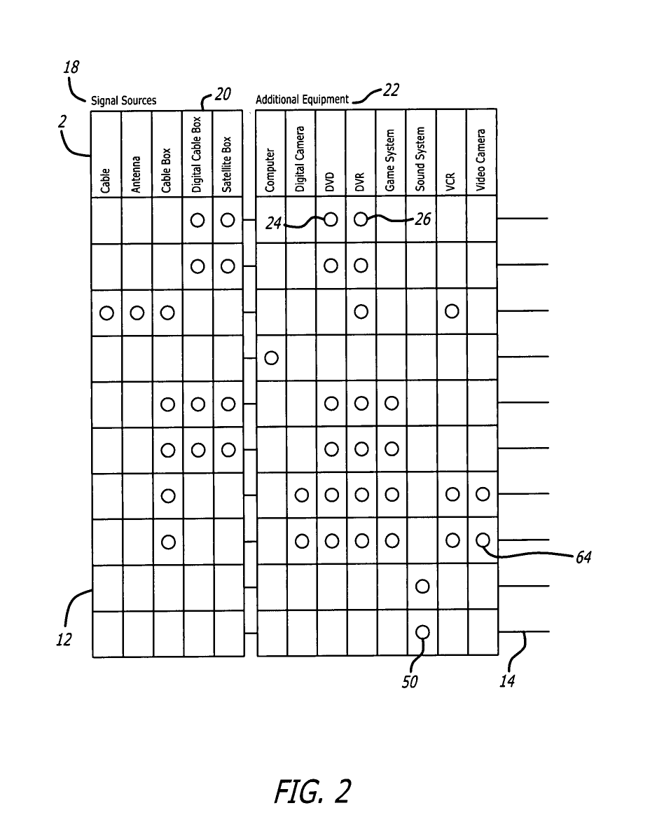

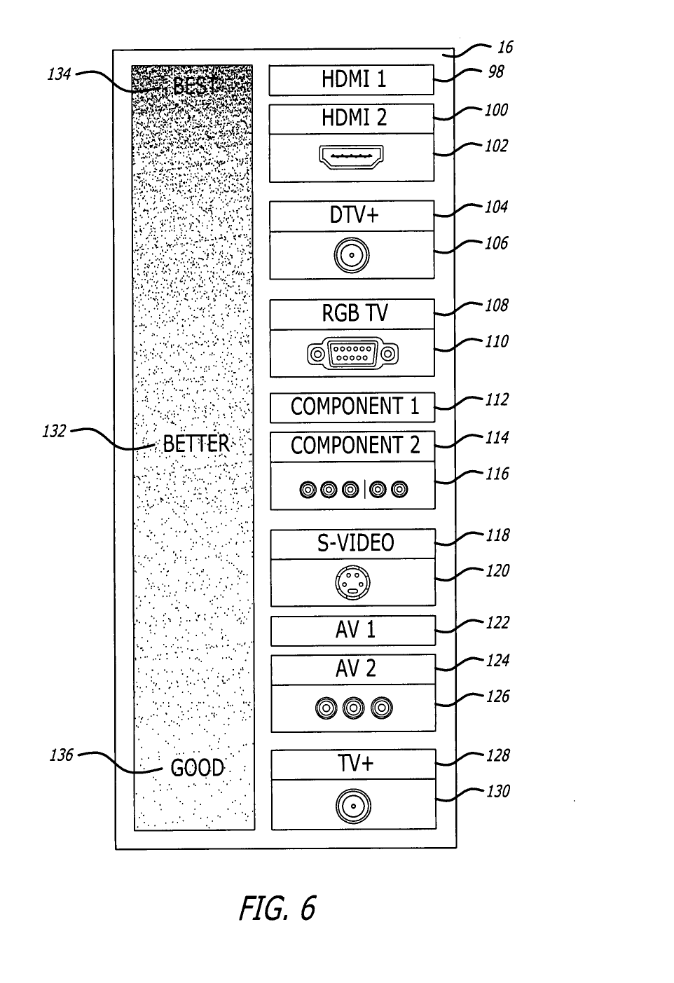

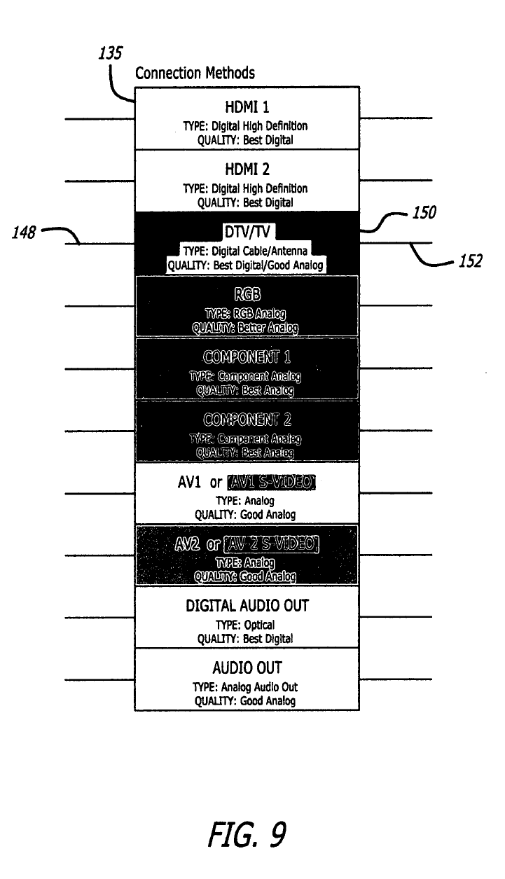

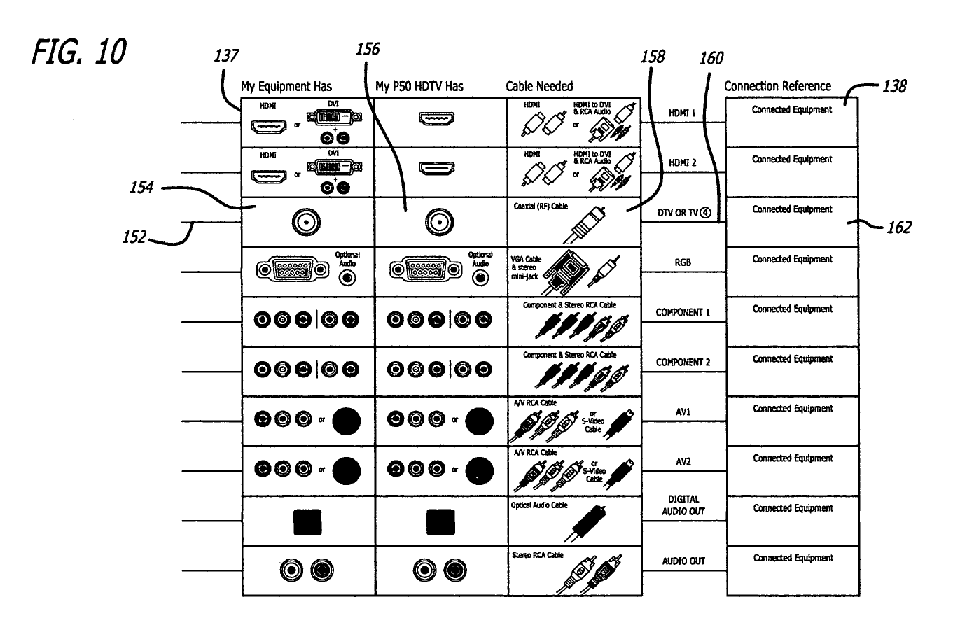

Not apparent in this figure (or FIGS. 2-5) is the color-coding of the invention. FIGS. 6-10 depict the color version of the chart shown in FIGS. 1-5 as an alternative embodiment. Shown as shading (and in color in FIGS. 6-10), each type of connection, seen in table two in element 4 is a different and distinct color. For example, DIGITAL HD1 is white, while ANALOG HD1 is green. The color coding substantially helps the user to readily distinguish between connection types and the necessary equipment to connect that type of connection properly.

The signal sources and equipment table 2, the connection methods table 4, the cable selector table 6 and the connection reference table 8 are aligned horizontally. Each table consists of an identical number of rows, such as row 12 and is connected by a series of color-coded connection lines 14. Each of the rows corresponds to one unique set of inputs located on the television, as seen in signal sources and equipment table 4. The types of inputs available on a television set are typically industry standard. However some of those industry standards may not be available on a given set and others may. Also, varying numbers of each type, may be available. For example, there are two HDMI inputs, such as HDMI 1 connection 30, on this television.

Additional features of the chart of FIG. 1 include best connection legend 16 and connection map 10. The best connection legend 16 provides a legend for the color-coding scheme that is utilized in the signal sources and equipment table 2, the connection methods table 4, the connection map 10 and the connection lines 14. The best connection legend 16 further provides an easy-to-understand and at-a-glance rating of the “quality” of the various connection methods. For example, HDMI connections are the best quality, whereas AV 1 connections are less high-quality.

Connection map 10 provides a diagram of the television set panel were the inputs in the best connection legend 16 and the connection methods table 4 are located. For purposes of ease of use, the vertical and color-coded connection methods table 4 virtually identically matches up to the physical connections provided on the device being described which is visible in the connection map 10. Mentally turning the connection methods table 4 counter-clockwise on its side allows a user to see that it virtually identically matches the connection table 10 and the physical connections on the device. This aids users in finding the physical connection in the back of the display once they have determined which connection to use through using the chart.

FIG. 1 and the benefit of using a chart as described in this method may be may more easily be understood by way of an example. A user of this chart would receive it along with their new television in the box. A user would remove his or her old television or find the place he or she wishes to place the television. Typically, not readily apparent to an end user is the quality of each of the multiplicity of varied connections. The best connection legend 16, described above, is useful to the user as a preliminary step in determining which types of connections to use. When possible, a user can quickly see, using the best connection legend 16, which connections are better than other connections. The simple and color-coded best connection legend 16 shows that a user should choose HDMI 1 over COMPONENT 1 if possible, given the electronic equipment to be connected.

Once a user has determined which connections to prefer, using the best connection legend 16, the first step is to look to the signal sources and equipment table 2 and determine which signal source 18 the user has. If the signal source 18 is a digital cable box 20, then there are two options, for this particular television. Also apparent are other devices to which the digital cable box 20 may be connected to in additional equipment 22. These additional equipment 22 are electronics that may be connected, between the signal source and the television. The two options are DVD 24 and DVR 26. A user may select either of these electronics to connect between the digital cable 20 and the television.

The user then looks to the connection methods table 4 and determines which type of connection is used to connect the digital cable box 20. These two tables, the connection methods table 4 and the signal sources and equipment table 2 are connected by a color-coded line, matching the color of the connection type and the color used in the best connection table 16. For example, connection lines 14 connecting these two tables are white between the digital cable box and HDMI 1 connection 30. However, near the bottom of the tables the connection lines 14 are grey, matching, for example the audio out 52 connection.

HDMI 1 connection 30 is one of the connection types that may be used to connect the digital cable box 20. To determine this, the user need only follow the color-coded (in this case white) line that connects the signal sources 18 digital cable box 20 to the additional equipment 22 and to the connection method 28.

Next the user looks to cable selector table 6, again following the color-coded (in this case white) line. The user then looks to the my equipment has column 32. This column 32 depicts the various connections available for that connection type on the device a user is connecting. In the preferred embodiment, each of the rows corresponds to the rows associated with each type of color-coded connection. Here, in HDMI 1 connectors box 34, there are detailed depictions of the types of connections that a user would need in order to make this connection properly. In the preferred embodiment, very accurate details of the ends of the cables are depicted. Here, a HDMI cable and a DVI with RCA audio are depicted. Either of those connection types will work, dependant upon the next two columns.

In the my P50 HDTV has column 36, details of the connection available on the television (in this case) are depicted. Here the HDMI connector 38 is shown. The P50 only has an HDMI connector 38 for this connection type on the television. Next, the user may look at the cable needed column 40. This shows the types of cables needed for a given connection type. The HDMI cable to DVI with RCA audio cable is shown or in the alternative an HDMI to HDMI cable in the connection type box 42 associated with this row. This shows, both ends, in substantial detail, of the cable needed to connect the device to this connection type. The user is now fully aware of the appearance of both ends of the connection, the best type of connection to make and the appropriate cable to use to make that connection.

Finally, still following the color-coded line to the right, the connection reference table 44 is a column dedicated to notes made by the user/installer. In the connected equipment box 46, the user may make notes or perhaps write a “connection number” if he or she has labeled the cable her or she has used to connect the two pieces of equipment. At each step along the way, the user is guided by the chart. Once the first piece of equipment is connected by this means, the user may then return to the far left signal sources and equipment table 2 and begin the process again for a different piece of equipment, for example, the sound system 50.

If, at any time, the user is unclear where to connect the cable on the television, there is the connection map 10, whereby the user may visually see a layout of the connections available on the television and their relative location. For example, using this connection map 10, which is also color-coded, a user may see that the HDMI 1 connection 30 is available on the back of the television (in this case) at HDMI 1 connection 48 located to the far left of the connection map 10.

In similar fashion a user may wish to connect this sound system 50 to the television. Following the connection lines 14 to the right shows that this may only be connected to the audio out 52 of the television. The my equipment has column 32 depicts the ends, color coded in one embodiment, of two RCA connectors 54.

The my P50 HDTV has column 36 shows that the television also has two RCA connectors 56. The cable needed column 40 shows a detailed depiction of the type of cable needed as an RCA cable in connection type box 58. Continuing to follow the chart to the right, a user may use the connection lines 14 to fine the connected equipment box 60 in which he or she may input the type of equipment used or other reference notes. Finally, the user may look to the connection map 10 to see the layout of the RCA connections in the audio out connector 64 on the television.

Turning next to FIG. 2 there is shown the details of signal sources and equipment table 2. The signal sources 18 represent the possible signal sources, such as digital cable box 20 and other equipment that can be connected to the television. It is common in the art for each signal source or piece of equipment to be connected to the television set by one or more connection methods. The placement of dots, such as sound system 50 into the different rows, such as row 12 represents which inputs on the television set to which a given signal source or equipment may be connected. In the additional equipment 22, each of these dots, such as sound system, is color-coded to correspond to the type of connection depicted. The dot for the sound system 50, in this example chart is black, where the dot for video camera 64 is orange, corresponding to a different connection type. Similarly, the DVD 24 and DVR 26 dots are white.

Signal sources and equipment table 2 is concerned with the possible inputs that can be used. The identity of the inputs is determined in connections methods table 4. The color of the dot, such as dot 48 indicates which connection method that the signal source or piece of equipment is capable of, according to the color-coding legend in best connection legend 16. Those skilled in the art will know that the dots may be replaced by any number of indicators including, but not limited to, checkmarks, X symbols, diamonds or crosses, colors, hatching, or shading.

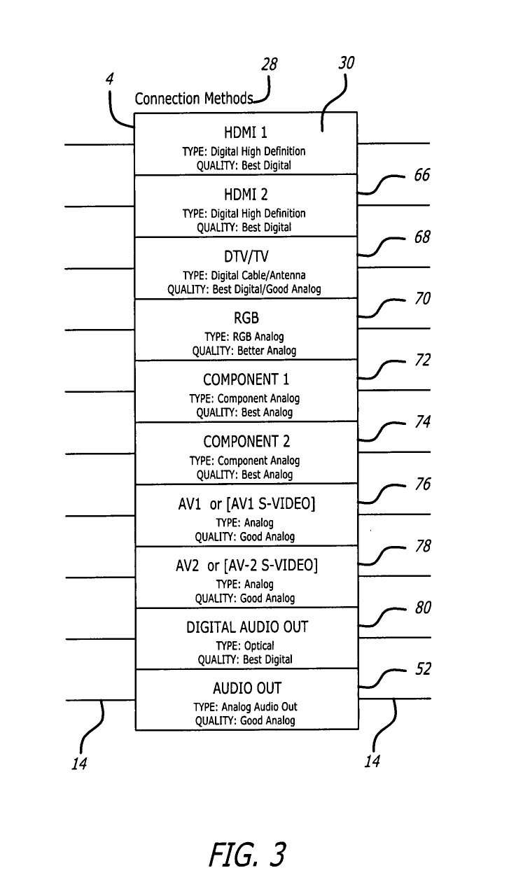

In order to move on to the next figure, FIG. 3, the user follows the parallel horizontal lines 14 that connect the connection methods table 4 to the signal sources and equipment table 2 and the cable selector table 6. Each row has a corresponding, color-coded (in the preferred embodiment) line, such as connection lines 14, connecting it to the next table. These corresponding row, connected by connection lines 14, guide a user through each step in the process described abstractly and by way of example above. Each row is labeled the same as the connection methods 28 that it is associated with. Furthermore, the color of each row is determined by the color-coding legend in the best connection legend 16. In alternative embodiments, different color-schemes may be employed. Alternatively, hatching, shading, or varying indicators may be used to delineate one “line” or series of connections between the rows of each table.

Still referring to FIG. 2, the signal sources and equipment table 2 and connection methods table 4 are used in conjunction with each other. The user identifies what signal source or equipment that they wish to connect to the television and finds the signal source 18 column for that signal source in table one 2. The user then looks down the signal source 18 column to see which rows 12 have colored dots, such as dot 48, in them to find out how many possible inputs the signal source or equipment can be connected to. Then the user follows the rows that have the colored dots, such as sound system 50 or video camera 64, in them across from the signal sources and equipment table 2 along the connection lines 14 to the connection methods table 4 to find out what television connection methods 28 are available to the user for that particular signal source or equipment. The user then selects which television connection methods 28 to connect their signal source or equipment to use from the connection methods table 4.

Referring now to the connections methods table 4 in FIG. 3 a detail of the various connection methods 28 available in this table is shown. These connection methods will, of course, vary from television (or other device) to television. Various televisions (or other devices) are supplied with different or more or fewer of the types of connections shown here. This table corresponds, exactly, to the available inputs and outputs on a given television.

The first has previously been discussed. It is HDMI 1 connection 30. The user may refer to the best connection legend 16 to determine that HDMI connections are the best connection type and may further refer to the connection map 10 to determine where these types of connectors are found on the television. The next connection method 28 is HDMI 2 connection 66. There is also a description of the type and quality of the connection method shown in the connection methods table 4. HDMI 1 30 and HDMI 2 66 are both digital high definition connections of the best digital quality.

Next, the DTV/TV connection 68 is shown. It is digital cable or antenna connection and is the best digital or good analog. Similarly, the RGB connection 70 is shown as RGB analog and “better analog” meaning that it is better than the analog options with indications other than “best.” Next is component 1 connection 72 and component 2 connection 74. These are both component analog connections that are the best analog.

Next, the AV1 or AV1 S-Video connection 76 and the AVI2 or AV-2 S-Video connection 78 are shown. These are analog connection types and are good analog. The digital audio out connection 80 is also shown. It is an optical connection, meaning that it uses light to communicate, and is the best digital audio output connection. The next is the audio out connection 52 which is analog audio out and is good analog.

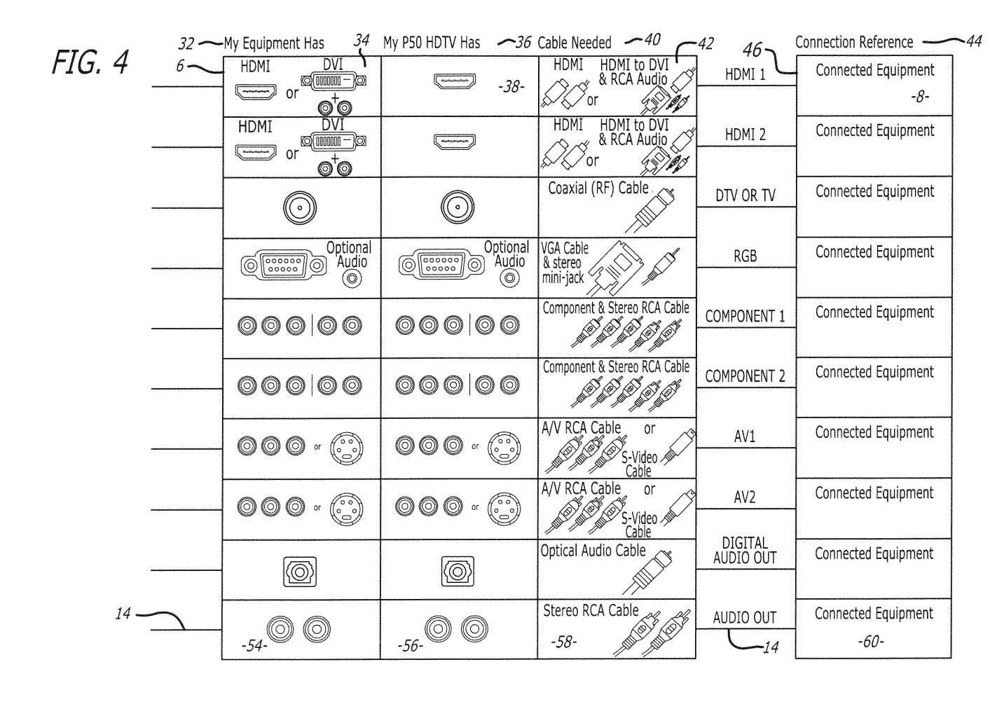

Turning next to FIG. 4, there is shown a detail of the cable selection table 6 and the connection reference table 8. As previously discussed, each row of both the cable selection table 6 and the connection reference table 8 corresponds to a television set input. Each row of the cable selection table 6 contains illustrations of the connections on the equipment in the my equipment has 32 column, the connections available on the television (or other device) in the my p50 hdtv has column 36 and the cable needed to connect them in the cable needed column 40. The illustrations are intentionally detailed enough such that the user may visually see the differences between the different cables, inputs and outputs. The illustrations are intended to allow, by sight alone, a user to review the chart and know each connection and cable needed to complete the connection process.

The cable selector table 6 is designed to work in conjunction with connection methods table 4. After the user selects which connection method that they want to use for a given signal source or equipment from connection methods table 4, the user follows the connection lines 14 across to the cable selection table 6. The corresponding row in the cable selection table 6 identifies to the user what the appearance of the connector for use with the device they are connecting in the my equipment has column 32. For example, if the device has HDMI or DIV and RCA audio as shown in HDMI 1 connection box 34, then this is the appropriate row to look to for connection help.

The user may next view the connections available on the television in the my p50 HDTV has column 36. The title of this column will, of course, change as the device changes. The connection available in the associated row is a HDMI connector 38 depicted accurately for ease of identification by an unfamiliar user. The next column, the cable needed column 40 they will need, which set of inputs to plug the cable into the connection type box 42 and which set out outputs to plug the cable into on the HDMI 1 connector box 34. Based on this information, the user will know exactly what cable they need to use, what the cable looks like, what the television set inputs they need to connect the cable to looks like and what the outputs they need to connect the cable to look like as well.

Finally, as described above, there is shown in the connector reference table 44 a reference to the user to identify which signal source or piece of equipment is connected to a given input. For the HDMI 1 connector 30 it is the connected equipment box 46. After selecting a connection method in the connection methods table 4, the user follows the rows all the way across to the connection reference table 8 and writes in the blank space which signal source or equipment is connected to that input. Alternative, the user may make any notes he or she wishes regarding the connection or any labeling of inputs or cables he or she has done.

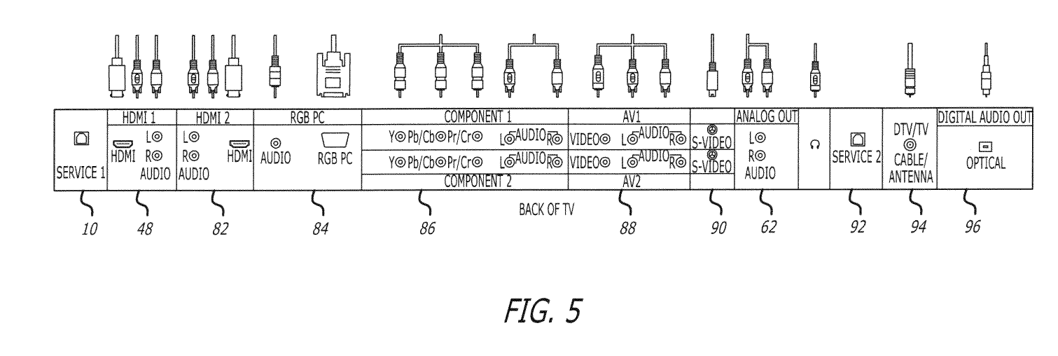

Turning next to FIG. 5, there is shown a detailed connection map 10, from FIG. 1. FIG. 5 is a re-creation of the panel (or panels in some embodiments) on the television that contains the various inputs and outputs available. As described above, the connection methods table 4 turned counter-clockwise to its left corresponds directly with this connection map 10. Each area that contains an input is colored according to the color-coding guide of best connection legend 16 and the colors used throughout the chart. Similarly, the connection methods table uses the same colors as well for ease of use.

The connection map 10 also shows the user which cables are associated with the different port types. The connection map is intended to be used as a reference alongside the cable selection table 6. After the user identifies which cables and inputs they should be utilizing to connect their signal source or equipment, they are to plug it in. However, in the case where the user cannot identify the inputs on the physical television set that they are to be using, they can refer to the connection map 10 to help them find the input on the physical television set. The color-coding (or alternative) scheme helps the user easily visually locate the specific sets of inputs 54 that they are looking for.

The first connection shown is HDMI 1 connection 30 (from FIG. 1 and FIG. 2). Here the connection and its appearance on the television are shown in HDMI 1 connector 48. HDMI 2 connector 82 is also shown exactly as it appears on the back of the television on the connection map 10. It is to be understood that the connection map 10 in the chart is reproduced, exactly, on the back of the electronic device (such as a television). The cables used to connect to these connections are pictured above them, accurately, so as to ease use for an individual unfamiliar with the connection type.

The next connection is RGB PC connection 84 on the connection map 10. This is the connection typically used with computers. More modern computers typically use a DVI connection, which, as can be seen from the cable selection table 6 are suitable for use with the HDMI 1 connection 48 or the HDMI 2 connection 82. Next the component 1 and component 2 connections 86 are shown along with the associated cables above the connections 86.

Next, the AV1 and AV2 connections 88 are depicted, just as they appear on the television. Next to these are the AVI S-Video 1 and AVI S-Video 2 connections 90 associated with AV1 and AV2 connections 88. Shown next to these connections 90 are the audio out connections 62. The service 2 connection 92 is shown, where a remote diagnostic may be run by a repairperson in order to determine any issues with the television. The DTV/TV cable/antenna connection 94 is used to connect the television directly to an exterior digital or analog antenna or cable. This is, in this depiction, the only out-of-order connection as compared with the connection methods table 4. The digital audio out connection 96 is also shown to which a user may connect an optical audio out connector for use with digital output audio.

FIG. 6 shows a close-up of the best connection legend 16. Each of the available connections are depicted herein. The primary purpose of the best connection legend 16 is to show at-a-glance the best connection type to use when given a choice. This is apparent in the indicator on the left varying from best 134 to better 132 to good 136. Near the top of the best 134 are the HDMI 1 connection 98 and HDMI 2 connection 100. Underneath these is the depiction of the way these connection types appear in the HDMI connector 102.

Next is the DTV+ connection 104, indicating that it is high quality, but, lower quality than either HDMI 1 connection 98 or HDMI 2 connection 100. The depiction of this connection type is shown in the DTV+ connector 106. Next is the RGB TV connection 108 and the visible depiction of the RGB TV connector 110. Next are the component 1 connection 112 and the component 2 connection 114. The component connectors 116 are also seen so that the user may easily tell which connector-type to use.

Lower down the best 134, better 132 and good 136 scale is the S-Video connection 118. Its connector type, similar to that of a PS/2 mouse, is shown in element 120 for ease of understanding by those not used to this type of connector. Next, a little less high-quality of a connection is shown in the AV1 connection 122 and the AV2 connection 124. The connectors of this type are shown below these labels as AV connectors 126. Finally, the TV+ connection 128 is shown to be lower quality than other connections. This corresponds to non-digital cable or antenna connection. The connection is depicted in TV+ connector 130.

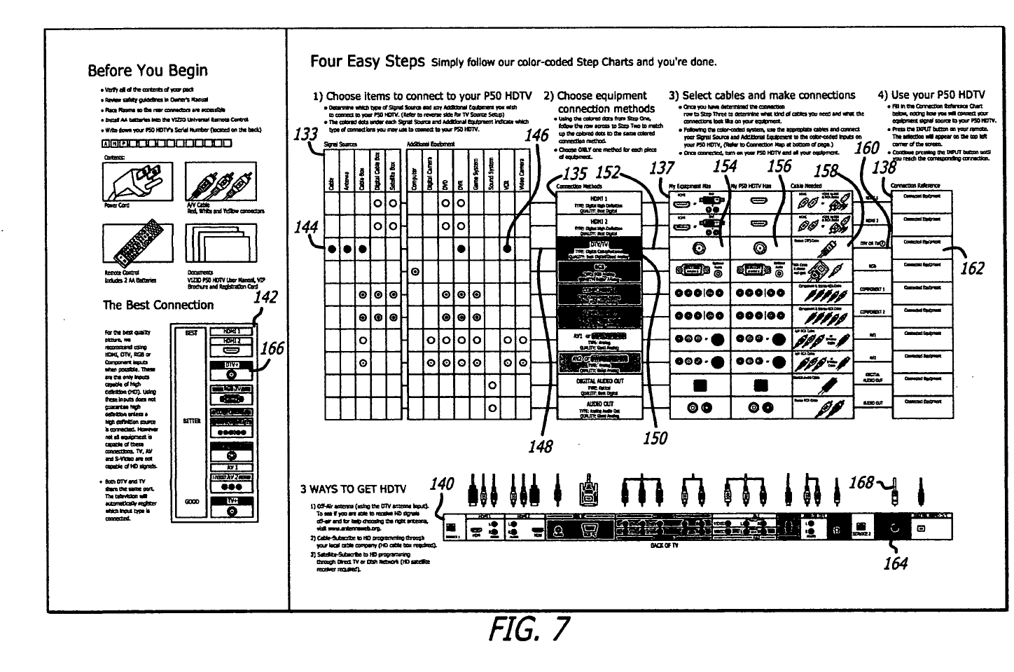

Referring now to FIGS. 7-10 an alternative color embodiment of the invention is shown. This chart is identical, except for the inclusion of color, to the embodiment shown in FIGS. 6-12. In this embodiment including color, it may more easily be seen the ways in which the chart is an improvement over the prior art. Each row, for example, row 146, is color-coded. Every element in row 146 is the same color. This color-coding aids the user in reading the chart.

Referring to FIGS. 7-11, the signal sources and equipment table 133 is shown in color along with the connection methods table 135, the cable selector table 137 and the connection reference table 138. The connection map 140 is also in color along with the best connection legend 142. Each row, across the entirety of the chart is color-coded, so that a user may readily understand that the row corresponds to a particular type of cable, connection to the electronic device and connection to the output or input device.

In row 144, all elements are black, so as to aid in ease of reading for an end-user. Other rows are blue, yellow, purple, green, white and grey as can be seen. Each row corresponds to a particular type of connection method. It is to be understood that any coloring or shading may be used.

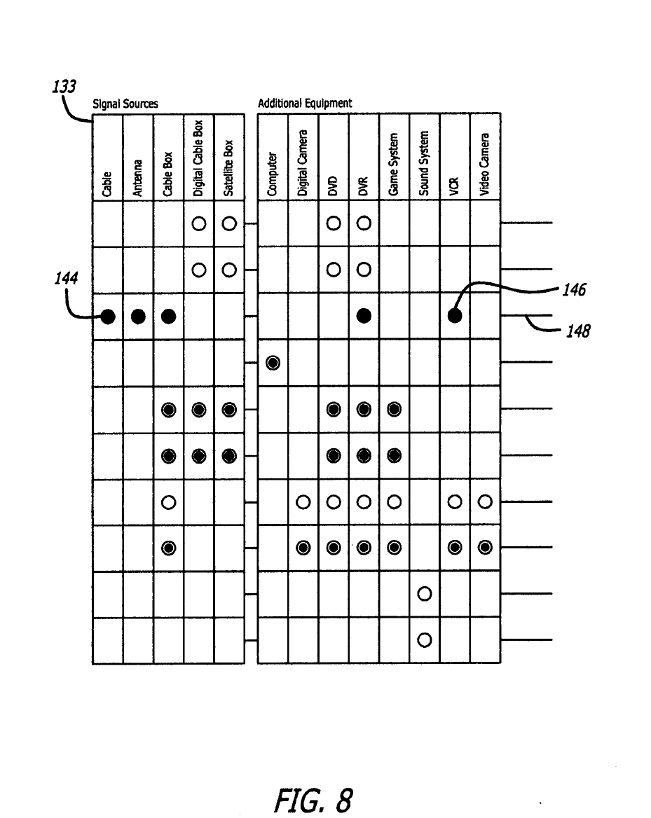

The VCR dot 146 (See FIGS. 7 and 8) is shown in back indicating that in row 144 the VCR may be connected between the signal sources in row 144 and the television. The cable selector table 137 may be used to select the appropriate connections.

Referring to FIGS. 7, 9 and 10, the connector line 152 connecting the cable selector table 137 to the connection methods table 135 is also black. The appropriate connection cable may be chosen by reviewing the DTV equipment box 154, the p50 connection box 156 and using the appropriate cable, shown in the DTV cable box 158. This is connected to the connection reference table 138 by another black connector line 160. The connected equipment box 162 in the connection reference table 138 may be used to make any notes the user desires.

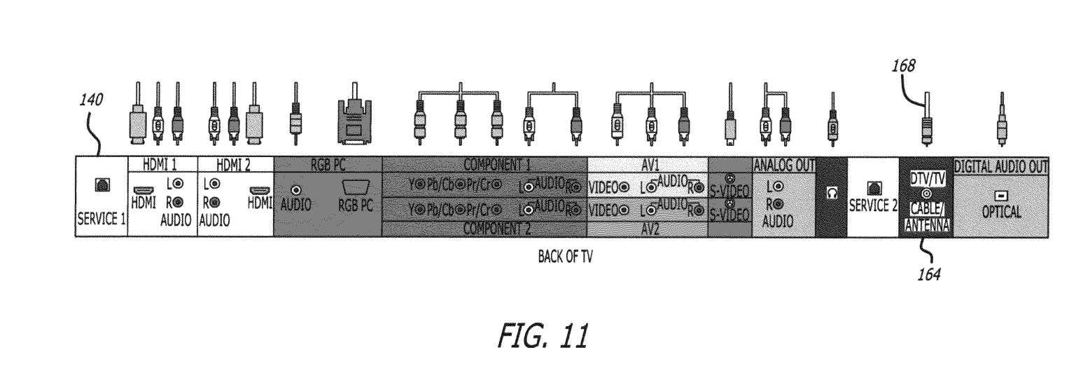

Referring now to FIG. 11, the connection map 140 may be used to see where a particular connection may be made. As can be seen the DTV/TV connector 164 is also color-coded such that it may be easily correlated to the appropriate line of connection information from the chart. Additionally, a high-quality and color representation of the cable 168 needed to connect to this input or output is also depicted.

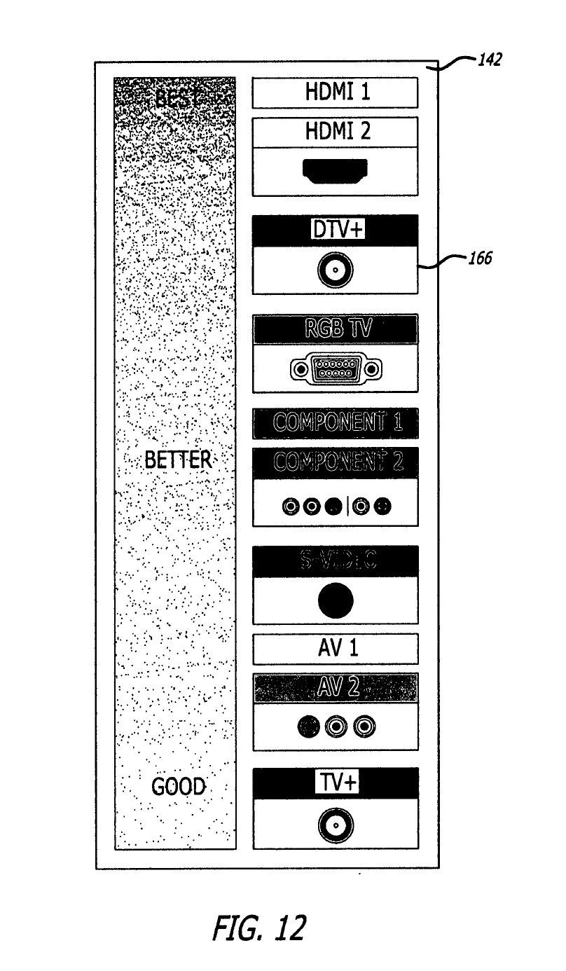

Referring now to FIG. 12, as previously, the best connection legend 142 may be used to select which type of connection to prefer over others, if available, ranking the connection types from best to better to good. The DTV connection 166, as can be seen in this chart is near the “best.”

The method of this invention may be employed with any type of electronic devices and in particular with electronics which require connection to other electronics. The method of this invention is a distinct improvement over the prior art. The use of diagrams of exemplary systems in the prior art has typically served to confuse the user and provide no real simplification to the connection or setup process. The method of this invention, applicable to any electronic device is much more easily understood and used. It is to be understood that color-coding and horizontal correspondence are not required elements of the foregoing invention. For example, the chart may oriented vertically and accomplish much the same effect. Alternatively, the chart may use corresponding symbols (for example Xs for all DIGITAL HD connections and Ys for all ANALOG HD connections) or hatching instead of color-coding across (or down) the chart while still providing the benefit of this chart.

Accordingly, a chart and methods of creating and using the chart to connect a variety of signal sources and equipment to a television has been described. It is to be understood that the foregoing description has been made with respect to specific embodiments thereof for illustrative purposes only. The overall spirit and scope of the present invention is limited only by the following claims, as defined in the foregoing description.

What is claimed is:

1. A chart for use in connecting electronic devices comprising:
at least one row of a table corresponding to one connection to a first electronic device;
at least one column corresponding to the means by which various electronic devices may be connected to said first electronic device.

2. The chart of claim 1, further comprising the additional element of lines, corresponding to said at least one row connecting each of said at least one column together.

3. The chart of claim 2, wherein at least one color is associated with said at least one row.

4. The chart of claim 3, wherein each of at least one row is associated with a different color.

5. The chart of claim 3, wherein said lines are colored, corresponding to said at least one color.

6. The chart of claim 1, wherein said columns correspond to at least one of the following:
(a) signal sources;
(b) electronic devices that may be connected to said first electronic device;
(c) connection methods that may be used;
(d) the type of cable needed for said connection method;
(e) the type of connection that at least one of said electronic devices may use; and
(f) the type of connection that said first electronic device may use.

7. The chart of claim 5, wherein at least one of said columns contain detailed depictions of the connection cables that may be used.

8. The chart of claim 3 further comprising a depiction of the connection cables used to connect to said first electronic device and a detailed depiction of the connections available on said first electronic device to which said connection cables connect.

9. The chart of claim 3 further comprising a depiction of the types of connections to said first electronic device and their relative quality.

10. The chart of claim 7 wherein said depiction of the cables includes color coding corresponding to said at least one row.

11. The chart of claim 8 wherein said depiction of the types of connections includes color coding corresponding to said at least one row.

12. A chart for use in connecting electronic devices comprising:
at least one row of a table corresponding to one connection on a first electronic device;
at least one color being associated with said at least one row;
said at least one row having columns corresponding to at least one of the following:
(a) signal sources;
(b) electronic devices that may be connected to said first electronic device;
(c) connection methods that may be used;
(d) the type of cable needed for said connection method;
(e) the type of connection that at least one of said electronic devices may use; and
(f) the type of connection that said first electronic device may use; and
lines, colored corresponding to said color associated with said at least one row connecting each of said columns together.

13. A method of creating a chart for use in connecting electronic devices comprising the steps of:
creating at least one row of a table corresponding to one connection to a first electronic device;
creating at least one column corresponding to the means by which various electronic devices may be connected to said first electronic device.

14. The method of claim 13 further comprising the additional step of connecting said at least one column in said at least one row with lines.

15. The method of claim 13 further comprising the additional step of color-coding said at least one row.

16. The method of claim 14 further comprising the additional step of creating a different color-coding for each of said at least one row.

17. The method of claim 14 wherein said lines are color-coded corresponding to said connected at least one column.

18. The method of claim 13, wherein said columns correspond to at least one of the following:
(a) signal sources;
(b) electronic devices that may be connected to said first electronic device;
(c) connection methods that may be used;
(d) the type of cable needed for said connection method;
(e) the type of connection that at least one of said electronic devices may use; and
(f) the type of connection that said first electronic device may use.

19. The method of claim 18 wherein at least one of said columns contain detailed depictions of the connection cables that may be used.

20. The method of claim 15 further comprising the additional step of creating a detailed depiction of the connections available on said first electronic device and the types of connection cables that connect to each connection.

21. The method of claim 15 further comprising the additional step of creating a detailed depiction of the connections available on said first electronic device and the relative quality of those connections.

22. The method of claim 20 wherein said depiction of the connections includes color coding corresponding to said at least one row.

23. The method of claim 21 wherein said depiction of the connections includes color coding corresponding to said at least one row.

24. The method creating a chart for use in connecting electronic devices comprising:
creating at least one row of a table corresponding to one connection on a first electronic device;
creating at least one color being associated with said at least one row;
said at least one row having columns corresponding to:
(a) signal sources;
(b) electronic devices that may be connected to said first electronic device;
(c) connection methods that may be used;
(d) the type of cable needed for said connection method;
(e) the type of connection that at least one of said electronic devices may use; and
(f) the type of connection that said first electronic device may use;
creating a detailed depiction of the cables necessary to connect to each of said columns in said at least one row;
creating lines, colored corresponding to said color associated with said at least one row connecting each of said columns together;
creating a detailed depiction of the connections available on said first electronic device, including color-coding corresponding to said color associated with said at least one row and;
creating a detailed depiction of the relative quality of said connections available on said first electronic device, including color-coding corresponding to said color associated with said at least one row.
